(19) United States
(12) Patent Application Publication
(10) Pub. No.: US 2026/0287057 A1
(43) Pub. Date: Sep. 24, 2026

(54) SLAVE CYLINDER WITH STOP RING, METHOD FOR MOUNTING THE SLAVE CYLINDER AND DRIVE TRAIN WITH THE SLAVE CYLINDER

(71) Applicant: Schaeffler Technologies AG & Co. KG, Herzogenaurach (DE)

(72) Inventor: Kirill Prokhorov, Achern (DE)

(73) Assignee: Schaeffler Technologies AG & Co. KG, Herzogenaurach (DE)

(21) Appl. No.: 19/475,577

(22) PCT Filed: Mar. 20, 2024
(86) PCT No.: PCT/DE2024/100239

§ 371 Date: Oct. 15, 2025

(30) Foreign Application Priority Data
Apr. 19, 2023 (DE) 10 2023 109 812.8

(51) Int. Cl. F16H 63/30; F15B 15/14

(52) U.S. Cl. CPC F16H 63/3026; F15B 15/1428; F15B 15/1447

(57) ABSTRACT

A slave cylinder for actuating a coupling device includes a main axis, an annular housing, an annular piston and a stop ring. The annular housing includes an annular space surrounding the main axis, and an axial end face. The annular piston is arranged in the annular space and is axially movable between an engaged end position and a disengaged end position. The stop ring is arranged on the axial end face and pressure-welded to the annular housing to form an axial end stop for the annular piston in the disengaged end position. The annular piston delimits the annular space to create a pressure space between the annular piston and the annular housing, and the pressure space is arranged to be filled with a pressure medium.

### CROSS-REFERENCE TO RELATED APPLICATIONS

This application is the United States National Phase of PCT Appln. No. PCT/DE 2024/100239 filed Mar. 20, 2024, which claims priority to German Application No. DE 102023109812.8 filed Apr. 19, 2023, the entire disclosures of which are incorporated by reference herein.

### TECHNICAL FIELD

The present disclosure relates to a slave cylinder for actuating a coupling device. Furthermore, the disclosure relates to a method for mounting the slave cylinder and a drive train having the slave cylinder.

### BACKGROUND

Concentric slave cylinders (CSC) are commonly used in both hybrid and fully electric vehicle drives. These are used, for example, for separating the drive shaft from the output shaft and/or for changing gears. Such slave cylinders substantially consist of an annular housing and an annular piston which can be axially displaced in the annular housing, wherein the annular piston acts on a clutch when a master cylinder is actuated so that the clutch is actuated, in particular closed.

Document DE 10 2018 105 465 A1 discloses an annular piston for a slave cylinder, wherein the annular piston is formed in one piece and a sealing ring carrier is formed on the annular piston. An abutment structure is formed on a first region of the annular piston and is intended to interact with an end stop for the annular piston.

### SUMMARY

The present disclosure provides a slave cylinder design which is cost-effective and easy-to-mount.

Example embodiments arise from the following description and the appended figures.

The present disclosure relates to a slave cylinder which is designed and/or is suitable for actuating a coupling device. In particular, the slave cylinder is used to transmit a force and/or a movement to the coupling device in order to open or close the coupling device. In principle, the coupling device can be designed as a friction clutch, e.g., a multi-disk friction clutch. The coupling device may be designed as a form-fitting clutch, e.g., a dog clutch. The slave cylinder can be actuated hydraulically, for example. In particular, the slave cylinder is designed as a concentric slave cylinder (CSC).

The slave cylinder includes an annular piston and an annular housing. The annular piston is received in the axial direction with respect to a main axis between an engaged end position and a disengaged end position in an annular space of the annular housing surrounding the main axis. The annular piston and the annular housing may be arranged coaxially with respect to the main axis and/or concentrically with respect to one another. The annular housing may have a central through-opening, in particular a bore, through which at least one shaft can be guided in an installation situation of the actuating cylinder. The main axis may be defined by an axis of rotation of the shaft. The annular piston may be rotationally symmetrical with respect to the main axis.

The annular piston delimits the annular space axially with respect to the main axis, so that a pressure space which can be filled with an operating medium is formed between the annular piston and the annular housing. In particular, the annular space is designed to be open on one side in an axial direction delimited by the annular piston and closed in an opposite axial direction. When the slave cylinder is actuated, the pressure on the operating medium is increased. The actuating force is generated due to the increasing pressure in the pressure space and is transferred to the annular piston so that it is disengaged axially. In particular, the operating medium is a hydraulic fluid, specifically a hydraulic oil.

The slave cylinder has a stop ring which is designed and/or is suitable for forming an axial end stop for the annular piston in the disengaged end position. In particular, the stop ring is arranged on an axial end face of the annular housing. In particular, the stop ring is designed as a separate component which is connected in one piece to the annular housing during a mounting process in order to axially secure or delimit the annular piston in the annular space. The stop ring can be mounted on the annular housing either before or after the annular piston is mounted. In particular, the stop ring defines a first switching position of the dog clutch in the disengaged end position of the annular piston. The stop ring may be designed to be coaxial and/or concentric to the annular housing with respect to the main axis and/or rotationally symmetrical. In principle, the stop ring with an annular surface can define the axial end stop. Alternatively, the stop ring can, however, also have a stop contour that protrudes into the annular space and defines the axial end stop.

The stop ring may be connected to the annular housing via a pressure-welded connection. In particular, a pressure-welded connection is understood to be an integral connection which is created by a pressure welding process. For this purpose, the stop ring and the annular housing are welded together under pressure and heat. The heat can be generated by electrical current or by movement of mass, in particular by friction. The annular housing and the stop ring can be made of the same material. Alternatively, the annular housing and the stop ring can also be made of a different material, e.g., a different metallic material or a different plastic. The pressure-welded connection may be produced circumferentially and/or continuously around the main axis.

Current slave cylinders (CSC) consist of a multitude of small individual components, which makes mounting complicated. For example, in some applications, a separate piston stop is required, which is pushed onto the annular housing and fixed axially with a retaining ring. To ensure that the annular space remains sealed, the piston stop must also be sealed against the annular housing using an O-ring.

The pressure-welded connection thus proposes a fastening of the stop ring (piston stop) by a reduced number of components, since the retaining ring and O-ring are not required. The axial installation space can also be reduced because the space for the retaining ring is no longer required. A slave cylinder is thus proposed which has a cost-effective and easy-to-mount design.

In an example embodiment, it is proposed that the stop ring is connected to the annular housing via a friction-welded connection. In particular, a friction-welded connection is understood to mean an integral connection which is produced by friction welding, e.g., rotary friction welding. For this purpose, the stop ring and the annular housing are moved relative to one another under pressure and connected to each other at the contact surfaces by the resulting frictional heat. In particular, the friction-welded connection is formed in the circumferential direction with respect to the main axis between the stop ring and the annular housing, and the stop ring and the annular housing are subjected to pressure in the axial direction and rotated relative to one another in the circumferential direction to form the friction-welded connection. In particular, friction welding is to be understood as a welding process according to EN ISO 4063: Process 42.

Alternatively, it is proposed that the stop ring is connected to the annular housing via an ultrasonic-welded connection. In particular, an ultrasonic-welded connection is understood to be an integral connection which is created by ultrasonic welding. For this purpose, the stop ring and the annular housing are subjected to mechanical vibrations in the ultrasonic range under pressure and are connected to one another at the contact surfaces by the resulting frictional heat. In particular, the ultrasonic-welded connection is formed in the circumferential direction with respect to the main axis between the stop ring and the annular housing, and the stop ring and the annular housing are subjected to pressure in the axial direction and made to vibrate mechanically to form the ultrasonic-welded connection. In particular, ultrasonic welding is understood to be a welding process according to EN ISO 4063: Process 41.

A pressure-welded connection is thus proposed which can be easily automated so that the mounting process can be further simplified. In addition, a pressure-welded connection is proposed which is suitable for both metallic (non-ferrous) materials and plastics, which leaves a choice for the material used for the annular housing and the stop ring.

In one design implementation, the annular housing has an inner and an outer cylinder section, and the annular space is delimited in the radial direction by the two cylinder sections and the stop ring is connected to the inner cylinder section via the pressure-welded connection. The inner cylinder section may be used to axially guide the annular piston between the two end positions. In the simplest case, the stop ring can be arranged on an axial end face of the inner cylinder section. For this purpose, the stop ring has substantially the same inner diameter as the cylinder section. Alternatively, the inner cylinder section, however, can also be single- or multi-stepped, and the stop ring is arranged on a step of the inner cylinder section. For this purpose, the stop ring has a larger inner diameter than the cylinder section. In other words, the inner diameter of the stop ring substantially corresponds to an outer diameter of the inner cylinder section.

Optionally, the outer cylinder section can define an axial end stop for the annular piston in the engaged end position. For this purpose, the two cylinder sections are arranged coaxially and/or concentrically in relation to the main axis with respect to one another. The annular piston may have at least one seal holder for receiving a piston seal, which sealingly bears against the inner and/or outer cylinder section to seal the pressure space. The two cylinder sections may be formed from a common material section or in one piece. The proposed slave cylinder has a particularly simple mounting of the stop ring on the inner cylinder section.

In an example embodiment, the inner cylinder section has a pressure surface surrounding the main axis and the stop ring has a counter-pressure surface surrounding the main axis, and the pressure-welded connection is formed in the axial direction between the pressure surface and the counter-pressure surface. In particular, the stop ring and the inner cylinder section are subjected to a compressive force in the axial direction during mounting, so the pressure surface and the counter-pressure surface are axially connected or welded to one another by means of pressure welding. In particular, the pressure surface and the counter-pressure surface are each formed by an annular shoulder surface. Alternatively or optionally additionally, the pressure surface and the counter-pressure surface extend in a radial plane of the main axis. The pressure-welded connection may be formed exclusively in the axial direction between the pressure surface and the counter-pressure surface. A pressure-welded connection is thus proposed which can be easily produced in the axial direction.

In a further embodiment, the inner cylinder section has a centering surface surrounding the main axis and the stop ring has a counter-centering surface surrounding the main axis, and the stop ring and the inner cylinder section are centered relative to one another in the radial direction via the centering surface and the counter-centering surface. In particular, the centering surface and the counter-centering surface are each formed by a lateral surface. In particular, the pressure surface and the centering surface are formed by an annular shoulder surrounding the main axis. In particular, the stop ring and the inner cylinder section are centered in the correct position relative to each other during mounting via the centering surface and the counter-centering surface. In other words, when mounted in the radial direction, the stop ring is pre-centered on the inner cylinder section in a form-fitting manner in order to hold it in position during the pressure welding process. This can further simplify the mounting process and increase mounting safety.

In a further development, the slave cylinder has an additional piston seal which is designed and/or suitable for fluid-tight sealing of the pressure space in the disengaged end position of the annular piston. In particular, the piston seal is used to dynamically and/or permanently seal the pressure space. For this purpose, the piston seal bears in a surrounding sealing manner against the inner circumference of the annular piston. The stop ring has a surrounding seal holder which is designed and/or suitable for receiving the piston seal. The seal holder may be arranged on an outer circumference of the stop ring. In particular, the seal holder is designed as an annular groove surrounding the main axis. The proposed slave cylinder has a compact structure as well as a high level of operational reliability. In particular, the stop ring ensures a pressure- and vacuum-tight sealing of the pressure space.

In a further optional implementation, the annular piston has a stop contour which is designed and/or suitable for forming an axial end stop for the annular piston in the engaged end position, and the stop contour is arranged on an outer circumference of the annular piston. In particular, the stop contour interacts with the outer cylinder section, preferably with its end face, in the engaged end position. The stop contour can be formed in sections or around the entire circumference. For example, the stop contour is designed as a collar, web, flange or the suchlike surrounding the main axis. Optionally, the stop contour is used to axially secure a latching element, which is designed to lock the annular piston in the engaged and/or disengaged end position. The proposed slave cylinder has a small number of components and a compact structure.

The present disclosure further relates to a method for mounting the slave cylinder, as described above, in which:
the annular housing is provided;
the annular piston is mounted in the axial direction in the annular space of the annular housing; and
the stop ring is connected to the annular housing by means of pressure welding.

In principle, the annular piston can be mounted in the annular space before the stop ring is mounted. Alternatively, the annular piston can also be mounted in the annular space after the stop ring has been mounted. To mount the stop ring, it is arranged on an axial end face of the annular housing, in particular the inner cylinder section, and connected to the annular housing by applying pressure and heat. In principle, heat can be generated using electrical energy. The heat may be generated by friction between the pressure surface and the counter-pressure surface. For this purpose, the stop ring may be held or centered coaxially and/or concentrically on the inner cylinder section during the joining process. For this purpose, the stop ring can be pushed onto the cylinder section in such a way that the centering surface and the counter-centering surface come into contact with the main axis in the radial direction.

In an example implementation, the stop ring is connected to the annular housing by friction welding. The stop ring may be connected to the annular housing by means of rotary friction welding. For this purpose, the stop ring is rotated or oscillated around the main axis relative to the annular housing, wherein the annular housing remains stationary or is held in place. When an axial compressive force is applied, friction is generated or increased between the pressure surface and the counter-pressure surface, and the stop ring and the annular housing are plasticized in the region of the pressure surfaces and are connected to each other by subsequent axial upsetting.

Alternatively, the stop ring can be connected to the annular housing by means of ultrasonic welding. In particular, the stop ring and the annular housing are made to vibrate under pressure in the ultrasonic range in order to generate or increase friction between the pressure surface and the counter-pressure surface. When an axial compressive force is applied, friction is generated or increased between the pressure surface and the counter-pressure surface, and the stop ring and the annular housing are plasticized in the region of the pressure surfaces and are connected to each other by subsequent axial upsetting. A pressure welding process is thus proposed which can be automated in a simple and cost-effective manner, and the mounting effort of the slave cylinder can be reduced.

In a further development, the pressure surface and/or the counter-pressure surface has/have an energy director oriented in the axial direction. In particular, an energy director is understood to be a surrounding, molded-on contour which focuses the friction energy generated during the friction welding process, in particular during ultrasonic welding. The proposed pressure-welded connection has a particularly high strength and good sealing properties.

The present disclosure further relates to a drive train for a vehicle, having at least or, more precisely, one drive unit. It is possible for the electric drive unit to form the only traction machine for the vehicle. Alternatively, the vehicle has additional traction machines, for example additional electric drive units and/or an internal combustion engine to generate the drive torque. The electric drive unit can be assigned to a single driven wheel of the vehicle and/or be designed as a single-wheel drive. Alternatively, the electric drive unit is assigned to two driven wheels, e.g., of a common axle and/or is designed as an electric axle. In other embodiments, the electric drive unit can also be assigned to all driven wheels and/or wheels of the vehicle and/or be designed as an all-wheel drive.

The drive train has the coupling device as previously described. The coupling device is designed to decouple the drive unit in certain driving situations and/or to separate a drive torque path, the slave cylinder being designed and/or suitable for actuating the coupling device. In particular, the coupling device is designed as a separating clutch which is designed to separate the drive torque path downstream of the drive unit. This allows the drive unit to rotate without any drive torque being transferred to the driven wheels. In particular, the coupling device is closed in the engaged end position of the annular piston and open in the disengaged end position of the annular piston.

### BRIEF DESCRIPTION OF THE DRAWINGS

Further features, advantages and effects of the disclosure arise from the following description of exemplary embodiments. In the drawings:

FIG. 1 shows a schematic representation of a drive train as an exemplary embodiment; and

FIG. 2 shows a schematic representation of a slave cylinder of the drive train from FIG. 1.

### DETAILED DESCRIPTION

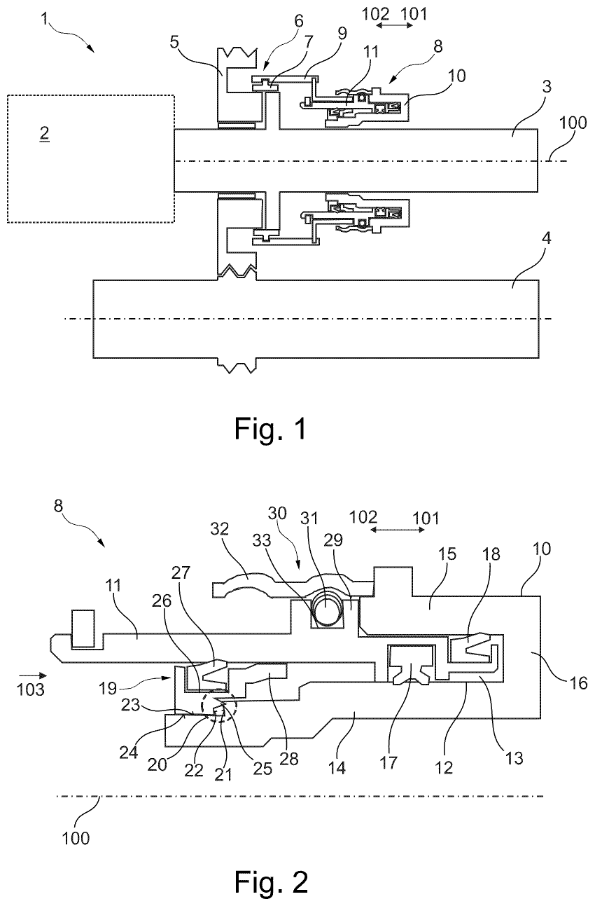

FIG. 1 shows a hybrid or electric drive train 1 of a vehicle in a schematic representation as an exemplary embodiment of the disclosure. The drive train 1 has at least one drive unit 2, only indicated schematically, which is connected in terms of drive to a drive shaft 3. The drive unit 2 is designed, for example, as an electric machine. The main axis 100 is defined, for example, by an axis of rotation of the drive shaft 3.

Furthermore, the drive train 1 has an output shaft 4, which is connected or can be connected to the drive shaft 3 by means of a transmission. For this purpose, the drive train 1 has a drive wheel 5 which is mounted coaxially with respect to a main axis 100 on the drive shaft 3 so as to be rotatable. The drive wheel 5 engages in a meshing manner with the output shaft 4. The output shaft 4 can, for example, be connected to at least one wheel, not shown, of the vehicle. Optionally, the output shaft 4 can be connected in terms of drive to another drive unit, e.g. another electric machine.

The drive train 1 has a coupling device 6 which is designed to couple the drive wheel 5 to the drive shaft 3 in a rotationally fixed manner. The coupling device 6 is designed as a dog clutch, and the coupling device 6, for this purpose, has a sliding sleeve 7 which is displaceable in the axial direction with respect to the main axis 100 between a coupling position and a decoupling position. In the coupling position, as shown in FIG. 1, the drive wheel 5 and the drive shaft 3 are connected to each other in a rotationally fixed manner. In the decoupling position, the drive wheel 5 and the drive shaft 3 can be rotated relative to one another. This allows the drive unit 2 to rotate in the decoupling position without any drive torque being transmitted to the output shaft 4.

The drive train 1 has a concentric slave cylinder 8 (abbreviated to CSC) which is arranged coaxially and/or concentrically with respect to the drive shaft 3. The slave cylinder 8 is used for actuating the coupling device 6, and the slave cylinder 8 is coupled in terms of motion to the sliding sleeve 7 via a gear rim 9.

The slave cylinder 8 has an annular housing 10 and an annular piston 11 which is received in the annular housing 10 and which is movable axially relative to the annular housing 11 with respect to the main axis 100 between an engaged and a disengaged end position 101, 102. The annular housing 10 and the annular piston 11 are arranged coaxially and concentrically with respect to the main axis 100. The annular piston 11 is connected in an axially fixed manner to the gear rim 9 such that the annular piston 11 axially displaces the gear rim 9 and thus the sliding sleeve 7. In the engaged end position 101, the sliding sleeve 7 is arranged in the coupling position; and in the disengaged position 102, the sliding sleeve 7 is arranged in the decoupling position.

In certain driving modes in which no drive energy is required, such as a coasting mode, the slave cylinder 8 is actuated to switch the coupling device 6 into the decoupling position. The drive shaft 3 and the output shaft 4 are thus separated from each other in terms of drive so that no energy is transferred to the wheels and the vehicle continues to roll without actively consuming energy from the battery. For example, the drive shaft 3 and the output shaft 4 can be synchronized via the drive units 2 before the switching process from the engaged end position 101 to the disengaged end position 102 so that the switching process runs “smoothly”.

As shown in FIG. 2, the annular housing 10 has an axially open annular space 12, and the annular piston 11 is received in the annular space 12 so as to be axially displaceable with respect to the main axis 100. The annular piston 11 bears radially sealingly against the annular housing 10 within the annular space 12 so that a pressure space 13 is delimited or sealed by the annular piston 11. For example, the slave cylinder 8 can be actuated hydraulically, and the pressure space 13 is filled with a hydraulic operating medium, e.g. hydraulic oil, in an operating state. For example, the operating medium is pumped into the pressure space 13 via a hydraulic pump, and a pressure in the pressure space 13 is increased and the annular piston 11 is moved from the engaged end position 101, as shown, to the disengaged end position 102.

The annular housing 10 has an inner and an outer cylinder section 14, 15, which delimit the annular space 12 in the radial direction. The two cylinder sections 14, 15 are arranged parallel to each other in the axial direction and are connected to each other via an end section 16, and the end section 16 delimits the annular space 12 in the axial direction.

To seal the pressure space 13, the slave cylinder 8 has an inner and an outer piston seal 17, 18, and the annular piston 11 bears sealingly against the inner cylinder section 14 via the inner piston seal 17 and against the outer cylinder section 15 via the outer piston seal 18. The two piston seals 17, 18 are each designed as an elastomer seal, in particular as groove sealing rings, which are fixed captively to the annular piston 11.

The slave cylinder 8 has a stop ring 19 which defines an axial end stop for the annular piston 11 in the disengaged end position 102. For this purpose, the stop ring 19 is fixed to the inner cylinder section 14 in the axial direction via a pressure-welded connection 20. For this purpose, the inner cylinder section 14 has a pressure surface 21 surrounding the main axis 100 and the stop ring 19 has a counter-pressure surface 22 surrounding the main axis 100, which are integrally connected to one another by means of a pressure welding process during a mounting process with the application of pressure and heat. The pressure surface 21 and the counter-pressure surface 22 each extend in a radial plane of the main axis 100

Furthermore, the inner cylinder section 14 has a centering surface 23 surrounding the main axis 100 and the stop ring 19 has a counter-centering surface 24 surrounding the main axis 100, via which the stop ring 19 is centered on the inner cylinder section 14 in the radial direction with respect to the main axis 100 during a mounting process. The pressure surface 21 and the lateral surface 23 or the counter-pressure surface 22 and the counter-centering surface 24 are each formed by an annular shoulder or a radial ledge surrounding the main axis 100. During mounting, the stop ring 19 is placed on the inner cylinder section 14 in the axial direction, and centering takes place by contact between the centering surface 23 and the counter-centering surface 24.

The stop ring 19 can then be connected to the inner cylinder section 14 by a friction welding process, such as rotary friction welding. For this purpose, the stop ring 19 is brought with the pressure surface 21 into contact with the counter-pressure surface 22 in the axial direction with respect to the main axis 100 and is moved relative to the annular housing 10, e.g. rotated about the main axis 100, and the annular housing 10 is held in place. Owing to the friction which arises between pressure surface 21 and counter-pressure surface 22, heat is generated and the material is plasticized. The pressure-welded connection 20 is created by applying a compressive force 103 to the stop ring 19 in the axial direction with respect to the main axis 100.

Alternatively, the stop ring 19 can be connected to the inner cylinder section 14 by an ultrasonic welding process. For this purpose, the stop ring 19 is brought with the pressure surface 21 into contact with the counter-pressure surface 22 in the axial direction with respect to the main axis 100, and the stop ring 19 and the annular housing 10 are caused to vibrate in the ultrasonic range. In this case, the pressure surface 22 can have an energy director 25, which is designed as a circumferential, molded-on material rib. The energy director 25 is used for introducing concentrated energy, which melts the material more quickly. The pressure-welded connection 20 is created by applying the compressive force 103 to the stop ring 19 in the axial direction with respect to the main axis 100.

The centering surfaces 23, 24 hold the stop ring 19 in the correct position during the entire joining process. This makes the friction welding process and the ultrasonic welding process easy to automate. In addition, the pressure-welded connection 20 is suitable for both metallic (non-ferrous) materials and plastics, which leaves a choice for the material used for the slave cylinder 8. The pressure-welded connection 20 also creates a pressure- and vacuum-tight connection of the stop ring 19 to the annular housing 10, thus eliminating the need for additional components such as retaining rings and O-rings. As a further advantage, the axial installation space of the annular housing 10 can be reduced because the space for the retaining ring is no longer required.

The slave cylinder 8 has an additional piston seal 27, which is used to seal the annular space 12 or the pressure space 13 in the disengaged end position 102 of the annular piston 11. For this purpose, the stop ring 19 has a seal holder 26 on its outer circumference, in which the piston seal 27 is fixed. For example, the additional piston seal 27 is designed as an additional elastomer seal, in particular as a groove sealing ring. The additional piston seal 27 bears radially surrounding against an inner circumference of the annular piston 11. The pressure-welded connection 20 and the piston seal 27 thus ensure a secure sealing of the pressure space 13.

The stop ring 19 also has a stop contour 28 which projects into the annular space 12, via which the annular piston 11 in the disengaged end position 102 is or can be axially supported on the stop ring 19. The stop contour 28 can be formed by a surrounding cylindrical projection which is formed directly on the stop ring 19. In addition, the annular piston 11 has an additional stop contour 29 for forming an axial end stop for the annular piston 11 in the engaged end position. The additional stop contour 29 can be designed as a collar surrounding the main axis 100, which is or can be supported axially on the outer cylinder section 15 in the engaged end position 101.

Furthermore, the slave cylinder 8 has a latching device 30, which serves to lock the annular piston 11 in the engaged and disengaged end positions 101, 102. The latching device 30 has a latching element 31 which is fixed to the annular piston 11 and interacts with a latching plate 32 fixed to the annular housing 10. For this purpose, the latching plate 32 has a latching contour into which the latching element 31 engages in the engaged and disengaged end positions 101, 102 in order to axially secure the annular piston 11. For example, the latching element 31 is spring-loaded so that the latching element 31 automatically engages in or disengages from the latching contour upon axial displacement of the annular piston 11. The latching element 31 is held axially on the annular piston 11 in a latching holder 33, and the latching holder 33 is formed with or delimited by the additional stop contour 29.

### REFERENCE NUMERALS

1 Drive train
2 Drive unit
3 Drive shaft
4 Output shaft
5 Drive wheel
6 Coupling device
7 Sliding sleeve
8 Slave cylinder
9 Gear rim
10 Annular housing
11 Annular piston
12 Annular space
13 Pressure space
14 Inner cylinder section
15 Outer cylinder section
16 End section
17 Inner piston seal
18 Outer piston seal
19 Stop ring
20 Pressure-welded connection
21 Pressure surface
22 Counter-pressure surface
23 Centering surface
24 Counter-centering surface
25 Energy director
26 Seal holder
27 Additional piston seal
30 Latching device
31 Latching element
32 Latching plate
33 Latching holder
100 Main axis
101 Engaged end position
102 Disengaged end position
103 Compressive force

1. A slave cylinder for actuating a coupling device, comprising:
an annular housing and an annular piston, wherein the annular piston is received movably in the axial direction with respect to a main axis between an engaged end position and a disengaged end position, in an annular space of the annular housing, said annular space surrounding the main axis, and axially delimits the annular space with respect to the main axis, so that a pressure space which can be filled with an operating medium is formed between the annular piston and the annular housing; and
a stop ring for forming an axial end stop for the annular piston in the disengaged end position, wherein the stop ring is arranged on an axial end face of the annular housing, wherein:
characterized in that the stop ring is connected to the annular housing via a pressure-welded connection.

2. The slave cylinder, according to claim 1, wherein the pressure-welded connection is designed as a friction-welded connection or an ultrasonic-welded connection.

3. The slave cylinder, according to claim 1, wherein the annular housing has an inner and an outer cylinder section, wherein the annular space is delimited in the radial direction by the two cylinder sections, wherein the stop ring is connected to the inner cylinder section via the pressure-welded connection.

4. The slave cylinder according to claim 3, wherein the inner cylinder section at its end has a pressure surface surrounding the main axis and the stop ring has a counter-pressure surface surrounding the main axis, wherein the pressure-welded connection is formed in the axial direction between the pressure surface and the counter-pressure surface.

5. The slave cylinder, according to claim 3, wherein the inner cylinder section has a centering surface surrounding the main axis and the stop ring has a counter-centering surface surrounding the main axis. wherein the stop ring and the inner cylinder section are centered relative to one another in the radial direction via the centering surface and the counter-centering surface.

6. The slave cylinder, according to claim 1, further comprising a piston seal for fluid-tight sealing of the pressure space in the disengaged end position of the annular piston, wherein the stop ring at its outer circumference has a surrounding seal holder for receiving the piston seal.

7. A method for mounting the slave cylinder of claim 1, comprising:
providing the annular housing is provided;
mounting the annular piston in the axial direction in the annular space of the annular housing; and
connecting the stop ring to the annular housing by pressure welding.

8. The method according to claim 7, further comprising connecting the stop ring to the annular housing by friction welding or by ultrasonic welding.

9. (canceled)

10. A drive train for a vehicle, comprising:
at least one drive unit;
a coupling device for decoupling the drive unit; and
the slave cylinder of claim 1 arranged for actuating the coupling device.

11. A slave cylinder for actuating a coupling device, comprising:
a main axis;
an annular housing comprising:
an annular space surrounding the main axis; and
an axial end face;
an annular piston, arranged in the annular space and axially movable between an engaged end position and a disengaged end position; and
a stop ring arranged on the axial end face and pressure-welded to the annular housing to form an axial end stop for the annular piston in the disengaged end position, wherein:
the annular piston delimits the annular space to create a pressure space between the annular piston and the annular housing; and
the pressure space is arranged to be filled with a pressure medium.

12. The slave cylinder of claim 11, wherein the stop ring is friction-welded or ultrasonic-welded to the annular housing.

13. The slave cylinder of claim 11, wherein:
the annular housing further comprises:
an inner cylinder section; and
an outer cylinder section;
the annular space is radially delimited by the inner cylinder section and the outer cylinder section; and
the stop ring is pressure-welded to the inner cylinder section.

14. The slave cylinder of claim 13, wherein:
the inner cylinder section comprises an end with a pressure surface surrounding the main axis;
the stop ring comprises a counter-pressure surface surrounding the main axis; and
the counter-pressure surface is pressure-welded to the pressure surface.

15. The slave cylinder of claim 13, wherein:
the inner cylinder section comprises a centering surface surrounding the main axis; and
the stop ring comprises a counter-centering surface surrounding the main axis that cooperates with the centering surface to radially center the stop ring relative to the inner cylinder section.

16. The slave cylinder of claim 11, further comprising a piston seal for fluid-tight sealing of the pressure space at the disengaged end position, wherein:
the stop ring comprises an outer circumference with a surrounding seal holder; and
the piston seal is arranged in the surrounding seal holder.
